(19) United States
(12) Patent Application Publication
(10) Pub. No.: US 2010/0254593 A1
(43) Pub. Date: Oct. 7, 2010

(54) System for Draping Meteorological Data on a Three Dimensional Terrain Image

(75) Inventors: Sherman L. Wilcox, Huntsville, AL (US); Robert J. Dreisewerd, JR., Huntsville, AL (US)

Correspondence Address: BRADLEY ARANT BOULT CUMMINGS LLP, 200 CLINTON AVE. WEST, SUITE 900, HUNTSVILLE, AL, 35801, US

(73) Assignee: Baron Services, Inc., Huntsville, AL (US)

(21) Appl. No.: 12/754,414

(22) Filed: Apr. 5, 2010

Related U.S. Application Data
(60) Provisional application No. 61/166,761, filed on Apr. 5, 2009.

(51) Int. Cl. G06K 9/00; G01S 13/95; G01S 13/00

(52) U.S. Cl. 382/154; 342/26 R; 342/179

(57) ABSTRACT

A system for draping meteorological data on a three dimensional terrain image has been developed. The system includes a central processing server that receives meteorological data in real time and drapes the meteorological data over a three dimensional terrain image. The image is then transmitted to a display computer for use by an end user.

### CROSS-REFERENCE TO RELATED APPLICATIONS

This application claims priority from U.S. Provisional Patent Application No. 61/166,761 titled “SYSTEM FOR DRAPING METEOROLOGICAL DATA ON A THREE DIMENSIONAL TERRAIN IMAGE” that was filed on Apr. 05, 2009.

### FIELD OF THE INVENTION

The invention relates generally to weather radar displays. More specifically, the invention relates to a system of layering weather data over a three dimensional terrain image.

### BACKGROUND ART

Weather broadcasts are some of the most highly rated features of news broadcasts. As competition for viewers increases, it is important to stations to put forth a weather broadcast that presents meteorological data in attractive and informative format. Presently, most weather displays on a broadcast present data, such as radar displays, in a two-dimensional (2D) format. The 2D displays are common and can be boring. Consequently, a three dimensional (3 D) display would be greatly desired since it would be able to bring dramatic and informative displays of weather data to the viewer.

### SUMMARY OF THE INVENTION

In some aspects, the invention relates to a system for draping meteorological data on a three dimensional terrain image, comprising: a central processing server configured to receive meteorological data in real time and drape the meteorological data over a previously designated three dimensional terrain image; and a display computer that receives a data transmission of the meteorological data draped over the three dimensional terrain image.

In other aspects, the invention relates to a system for draping meteorological data on a three dimensional terrain image, comprising: means for receiving multiple streams of meteorological data in real time; means for draping the streams of meteorological data over a previously designated three dimensional terrain image; and means for transmitting the meteorological data draped over a three dimensional terrain image to an end user.

In other aspects, the invention relates to a method for draping meteorological data on a three dimensional terrain image, comprising: step for receiving multiple streams of meteorological data in real time at a central processing server; step for the streams of meteorological data over a previously designated three dimensional terrain image at the central processing server; and step for transmitting the meteorological data draped over a three dimensional terrain image to an end user's display computer.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows an example of three dimensional image of mountainous terrain.

FIG. 2 shows an example of meteorological radar images draped on a three dimensional terrain image in accordance with an embodiment of the present invention.

FIG. 3 shows an example of a three dimensional thunder storm image draped on a three dimensional terrain image in accordance with an embodiment of the present invention.

FIG. 4 shows an example of a three dimensional thermometer image draped on a three dimensional terrain image in accordance with an embodiment of the present invention.

### DETAILED DESCRIPTION

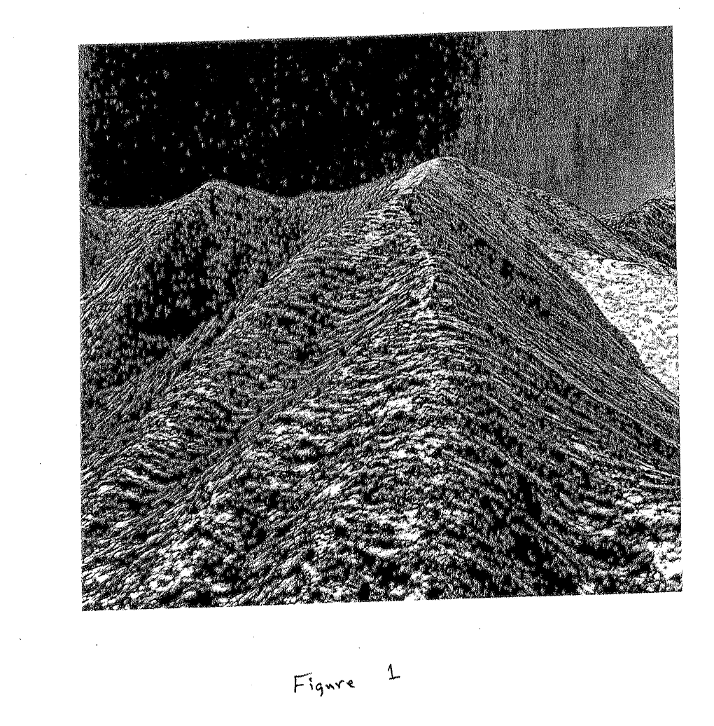

A system and method for draping meteorological data on a three dimensional (3D) terrain image has been developed. The system can also render 3D graphics of live radar data and deliver lifelike models of terrain and landmarks around the world. FIG. 1 shows an example of such a three dimensional image of mountainous terrain.

The system also contains high-definition (HD) data products, aerial mapping, nationwide and worldwide topography, ocean depth mapping, political boundaries, and an earth halo effect in a completely renderless display. In one example, the 3D modeling can add local landmarks such as sports stadiums and include on-site anemometer data to show the current winds.

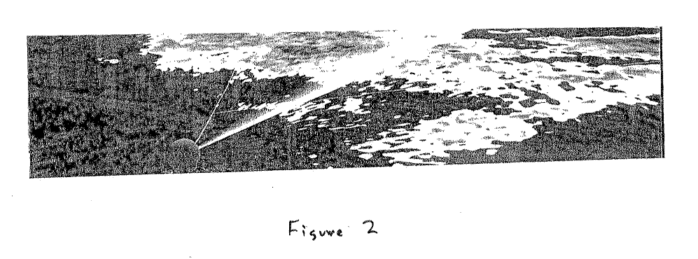

The 3D modeling overlay can also incorporate radar data from additional radar stations into a 3D composite display. In one example, the system can instantly render 3 D graphics of satellite and radar data from multiple sources to show a hurricane forming off the coast of Africa that might make its way to Florida. The present invention has been able to integrate live data from up to 20 sources at one time. FIG. 2 shows an example of meteorological radar images draped on a three dimensional terrain image.

The system includes software that is loaded and stored at a broadcaster's facilities with data provided from the U.S. Weather Service and other radar and satellite sources. The data may be transmitted via the Internet. The basic system features and functionality include:
a 720p/1080i High Definition (HD) display;
integration of HD weather data and high resolution true-to-life worldwide aerial mapping and terrain in a no-render system which provides the ability to take viewers on true HD weather flights both locally and worldwide;
3D model integration including actual 3D cityscapes and 3D objects (some of which can be driven by actual weather data) which can be incorporated into the weathercast for a unique visual style;
live sensor integration offering unique visualization of real-time weather data;
HD data delivered directly in an auto-updating environment and providing the flexibility to display multiple products simultaneously from multiple sites with extensive lapsing;
data integration allowing the user to display multiple unique data products;
an easy to use graphical user interface that allows for system set-up, show set-up, and show playback from a single frame to a complete sequence; and
a “sketch” application providing the ability to create a complete weather show, including: complete banner and logo support, text overlays, graphic pages, auto-updated forecast and current conditions pages, live video and video on file integration.

The types and classes of data supported by the system include: Live station radar; Reflectivity; Velocity; De-aliased Velocity; Storm Relative Velocity; Shear; Echo Tops; VIL; VIL Density; Precipitation Rate; Precipitation Accumulation (1, 3, 12, 24 hour rain/snow/mix accumulation);Heavy Rain; Snow Machine; and Heavy Snow. Other types of data include: Composite U.S. Reflectivity (Level 2 (2 km) and Level 3 (1 km)); Composite Level 3 U.S. radar data (24 hour accumulation, VIL Density, and Echo Tops); Satellite Products (10 km Worldwide Satellite, 4 km IR, 4 km Visible, 16 km WV, 4 km Ch4-Ch2 Fog Satellite imagery, and 1 km Visible for select sectors); Whole U.S. raster products (Current temperature, Current dew point temperature, Current wind speed, Current humidity, Current heat index, Current wind chill, and 24 hour max min and change in temperature); Lightning; Metar observations; NDFD Forecast data; 1 km/256 color Snow Cover. Also, various nautical, environmental and other data is supported, including: Local Storm Reports; Buoys; Earthquakes; Fire; Airport Delays; Air Quality (AQI and Ozone); Hurricane Products (Position, Track, Cone, Spaghetti plots, Wind probabilities, Wave Height, and Storm Surge), River Stage Information, and Worldwide Forecasts.

The system can also support video provided by Internet Based Webcams; Animation encoded MOV files; .MPEG files; a data from sensor networks such as FAWN. The system may also support and incorporate Numerical Model data from: RUC; GFS; NAM; BAMS; and a special 3 km BAMS model.

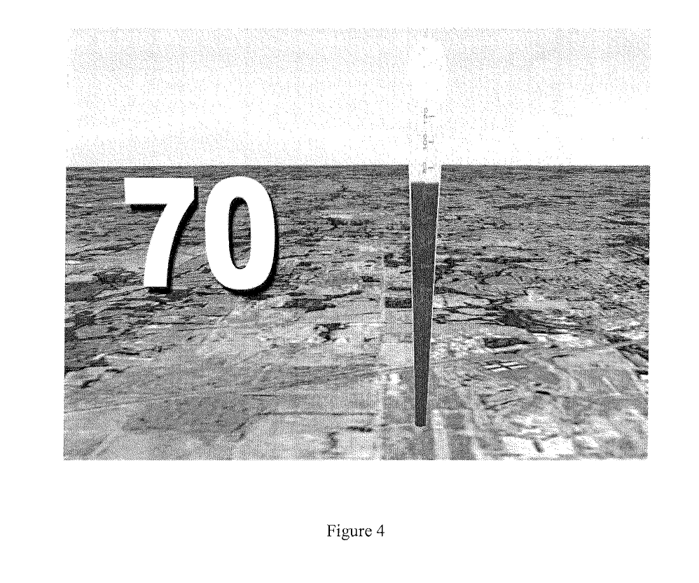

The present invention may display anemometers, thermometers, buoys, river gauges, road sensors, and snow sticks. Each of these items responds in real time directly to currently observed conditions as shown in FIG. 4. Additional tropical features are also available including the forecast cone, past position, sketch integration with tropical advisory information, spaghetti models as well as additional data products (SLOSH, Surface Wind Forecast, Tropical Wind Probability, Tropical Wave Height, Tropical Storm Surge Probability, HWRF model, Coastal Watches/Warnings).

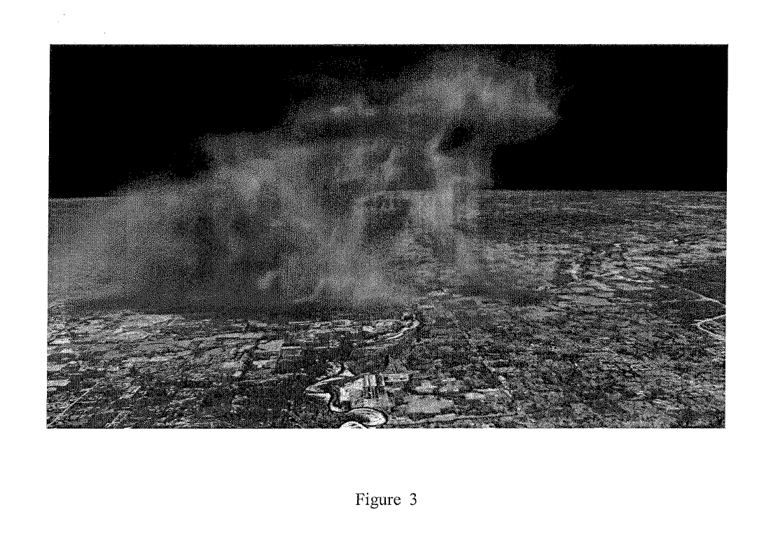

Some embodiments of the present invention utilize 64-bit Architecture for the system. When combined with a volumetric imager and GPS integration, the present invention has the ability to take a volume scan and in real time, create a 3 dimensional image of reflectivity. This allows viewing of a complete three dimensional storm structure as well as highlight areas of interest. The lighter areas of reflectivity can be edited out to see inside the storm and pick out areas of hail, or forming tornados as shown in FIG. 3.

The present invention has the capability of draping real time meteorological and related data over a three dimensional terrain depiction. The draped data can be obtained from various sources such as satellite data, radar, or over the internet. The data may be in various formats such as ASCII, NIDS, or other formats desired by the end user. In one embodiment of the present invention, the desired meteorological and related data are simultaneously collected in various formats by a central processing server. The server then arranges the data in a fixed format previously designated by the end user. The data is arranged and draped over a designated three dimensional terrain image designated by the end user. The draped data is then transmitted to the end user for their use. The data may be transmitted via the Internet, satellite, or other suitable data transmission path.

In one embodiment, the draped data is transmitted in XML format. The end user may adjust the types of data and the terrain images as needed. In some embodiments, the these adjustments are made by the end user upon receiving the draped data stream. In other embodiments, the adjustments are made at the central processing server.

It should be clear to one of ordinary skill in the art that the present invention has the advantage over the prior art of combining true 3-D models, terrain and data-driven meteorological animations into a real-time HD environment. While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A system for draping meteorological data on a three dimensional terrain image, comprising:
a central processing server configured to receive meteorological data in real time and drape the meteorological data over a previously designated three dimensional terrain image; and
a display computer that receives a data transmission of the meteorological data draped over the three dimensional terrain image.

2. The system of claim 1, where the central processing receives non-meteorological data in real time and drapes the non- meteorological data over the three dimensional terrain image.

3. The system of claim 1, where the meteorological data comprises multiple types of meteorological data that is received simultaneously by the a central processing server.

4. The system of claim 1, where the meteorological data is received via the internet.

5. The system of claim 1, where the meteorological data is received via satellite.

6. The system of claim 1, where the meteorological data is received via radar.

7. The system of claim 1, where the meteorological data is transmitted to the display computer via the internet.

8. The system of claim 1, where the meteorological data is transmitted to the display computer via satellite.

9. The system of claim 1, where the format of the meteorological data draped over the three dimensional terrain image is controlled at the a central processing server.

10. The system of claim 1, where the format of the meteorological data draped over the three dimensional terrain image is controlled at the display computer.

11. A system for draping meteorological data on a three dimensional terrain image, comprising:
means for receiving multiple streams of meteorological data in real time;
means for draping the streams of meteorological data over a previously designated three dimensional terrain image; and
means for transmitting the meteorological data draped over a three dimensional terrain image to an end user.

12. A method for draping meteorological data on a three dimensional terrain image, comprising:
step for receiving multiple streams of meteorological data in real time at a central processing server;
step for the streams of meteorological data over a previously designated three dimensional terrain image at the central processing server; and
step for transmitting the meteorological data draped over a three dimensional terrain image to an end user's display computer.
